(19) United States
(12) Patent Application Publication
(10) Pub. No.: US 2012/0169671 A1
(43) Pub. Date: Jul. 5, 2012

(54) MULTI-TOUCH INPUT APPARATUS AND ITS INTERFACE METHOD USING DATA FUSION OF A SINGLE TOUCH SENSOR PAD AND AN IMAGING SENSOR

(75) Inventor: Taizo Yasutake, Cupertino, CA (US)

(73) Assignee: PRIMAX ELECTRONICS LTD., Taipei (TW)

(21) Appl. No.: 13/305,505

(22) Filed: Nov. 28, 2011

Related U.S. Application Data
(60) Provisional application No. 61/429,273, filed on Jan. 3, 2011.

(51) Int. Cl. G06F 3/042

(52) U.S. Cl. 345/175; 178/18.09

(57) ABSTRACT

A system and method for generating a multi-touch command using a single-touch sensor pad and an imaging sensor is disclosed. The imaging sensor is disposed adjacent to the single-touch sensor pad and captures images of a user's fingers on or above the single-touch sensor pad. The system includes firmware that acquires data from the single-touch sensor pad and uses that data with the one or more images from the imaging sensor to generate a multi-touch command.

### CROSS-REFERENCE TO RELATED APPLICATION

This application claims the benefit of United States Provisional Application No. 61/429,273, filed Jan. 3, 2011, entitled MULTI-TOUCH INPUT APPARATUS AND ITS INTERFACE METHOD USING DATA FUSION OF A SINGLE TOUCHPAD AND AN IMAGING SENSOR, which is incorporated herein by reference.

### BACKGROUND OF THE INVENTION

Recent developments in the field of multi-touch inputs for personal computer provide improved input capabilities for computer application programs. Along with the innovation of the touch screen, the multi-finger, gesture-based touchpad provides considerably improved productivity when used as an input device over standard input devices such as conventional mice.

Currently, the standard touchpad installed on keyboards and remote controllers is a single-touch sensor pad. Despite its standard usage, the single-touch sensor pad has inherent difficulty in generating multi-touch inputs or intuitive multi-dimensional input commands.

Accordingly, a need exists for a single-touch sensor pad that has equivalent multi-touch input capability to a multi-touchpad or other multi-dimensional input devices.

### SUMMARY OF THE INVENTION

The present invention has been developed in response to problems and needs in the art that have not yet been fully resolved by currently available touchpad systems and methods. Thus, these systems and methods are developed to use a single-touch sensor pad combined with an imaging sensor to provide a multi-touch user interface. These systems and methods can be used to control conventional 2-D and 3-D software applications. These systems and methods also allow for multi-dimensional input command generation by two hands or fingers of a user on a single touchpad. The systems and methods also provide input commands made simply by hovering the user's fingers above the touchpad surface.

Implementations of the present systems and methods provide numerous beneficial features and advantages. For example, the present systems and methods can provide a dual-input mode, wherein, for instance, in a first mode, a multi-touch command can be generated by making a hand gesture on a single-touch sensor pad. In the second mode, a multi-touch input can be generated by making a hand gesture in free space. In operation, the systems and methods can operate in a first input mode when the single-touch sensor pad senses a touchpoint from a user's finger on the single-touch sensor pad. The system can switch to the second input mode when the single-touch sensor pad senses the absence of a touchpoint from a user's finger on the single-touch sensor pad.

In some implementations of the system, by using data fusion, the present systems and methods can significantly reduce the computational burden for multi-touch detection and tracking on a touchpad. At the same time, a manufacturer can produce the system using a low-cost single-touch sensor pad, rather than a higher-cost multi-touch sensor pad, while still providing multi-touchpad capabilities. The resulting system can enable intuitive input commands that can be used, for example, for controlling multi-dimensional applications.

One aspect of the invention incorporates a system for generating a multi-touch command using a single-touch sensor pad and an imaging sensor. The imaging sensor is disposed adjacent to the single-touch sensor pad and captures one or more images of a user's fingers on or above the single-touch sensor pad. The system includes firmware that acquires data from the single-touch sensor pad and uses that data with the one or more images from the imaging sensor. Using the acquired data, the firmware can generate a multi-touch command.

Another aspect of the invention involves a method for generating a multi-touch command with a single-touch sensor pad. The method relates to acquiring data from a single-touch sensor pad that indicates whether or not a user is touching sensor pad and where. The method also relates to acquiring images of the user's fingers from an imaging sensor. Firmware of the system can then use the acquired information and images to identify the user's hand gesture and then generate a multi-touch command corresponding on this hand gesture.

These and other features and advantages of the present invention may be incorporated into certain embodiments of the invention and will become more fully apparent from the following description and appended claims, or may be learned by the practice of the invention as set forth hereinafter. The present invention does not require that all the advantageous features and all the advantages described herein be incorporated into every embodiment of the invention.

### BRIEF DESCRIPTION OF THE DRAWINGS

In order that the manner in which the above-recited and other features and advantages of the invention are obtained will be readily understood, a more particular description of the invention briefly described above will be rendered by reference to specific embodiments thereof, which are illustrated in the appended drawings. These drawings depict only typical embodiments of the invention and are not therefore to be considered to limit the scope of the invention.

FIG. 1 illustrates a perspective view of a representative keyboard having a single-touch sensor pad and an imaging sensor.

FIG. 2 illustrates a perspective view of multi-touch input generation using a single-touch sensor pad and an imaging sensor.

FIG. 3 illustrates a usage of the imaging sensor as an independent input device.

FIGS. 4A and 4B illustrate a hand gesture (X-Y movement) over the imaging sensor and its captured image.

FIGS. 5A and 5B illustrate a hand gesture (Z movement) over the imaging sensor and its captured image.

FIGS. 6A and 6B illustrate a hand gesture (Z-axis rotation) over the imaging sensor and its captured image.

FIG. 7 illustrates the block diagram of representative hardware component of the present systems.

FIG. 8 illustrates the function block diagram of representative firmware of the present systems.

FIGS. 9A and 9B illustrate two finger locations and their local coordinates on the surface of single-touch sensor pad.

FIGS. 10A and 10B illustrate a binarized image and its coordinates of object (finger-hand) in an image.

FIG. 11 illustrates input gestures using one or two hands for generating multi-dimensional commands.

FIG. 12 illustrates a single finger based 2-D command generation for a 3-D map application using single-touch sensor pad.

FIG. 13 illustrates a hand gesture-based rotation/zoom command for a 3-D map application.

FIG. 14A illustrates a side view of an imaging sensor installed on a keyboard and user's finger before activation of a hovering command.

FIG. 14B illustrates the captured image of fingers by the imaging sensor before hovering command activation.

FIG. 15A illustrates a side view of an imaging sensor installed on a keyboard and a user's finger after activation of a hovering command.

FIG. 15B illustrates the captured image of finger by the imaging sensor after activation of a hovering command.

FIG. 16A illustrates a captured image frame at a previous time that is used for calculating the position change of fingertips along an X-axis during hovering action.

FIG. 16B illustrates a captured image frame at a current time that is used for calculating the position change of fingertips along an X-axis during hovering action.

### DETAILED DESCRIPTION OF THE PREFERRED EMBODIMENTS

The presently preferred embodiments of the present invention can be understood by reference to the drawings, wherein like reference numbers indicate identical or functionally similar elements. It will be readily understood that the components of the present invention, as generally described and illustrated in the figures herein, could be arranged and designed in a wide variety of different configurations. Thus, the following more detailed description, as represented in the figures, is not intended to limit the scope of the invention as claimed, but is merely representative of presently preferred embodiments of the invention.

The following disclosure of the present invention may be grouped into subheadings. The utilization of the subheadings is for convenience of the reader only and is not to be construed as limiting in any sense.

The description may use perspective-based descriptions such as up/down, back/front, left/right and top/bottom. Such descriptions are merely used to facilitate the discussion and are not intended to restrict the application or embodiments of the present invention.

For the purposes of the present invention, the phrase “A/B” means A or B. For the purposes of the present invention, the phrase “A and/or B” means “(A), (B), or (A and B).” For the purposes of the present invention, the phrase “at least one of A, B, and C” means “(A), (B), (C), (A and B), (A and C), (B and C), or (A, B and C).”

Various operations may be described as multiple discrete operations in turn, in a manner that may be helpful in understanding embodiments of the present invention; however, the order of description should not be construed to imply that these operations are order dependent.

The description may use the phrases “in an embodiment,” or “in various embodiments,” which may each refer to one or more of the same or different embodiments. Furthermore, the terms “comprising,” “including,” “having,” and the like, as used with respect to embodiments of the present invention, are synonymous with the definition afforded the term “comprising.”

The present input systems and methods can detect the 2-D coordinates of multiple fingertips on a single-touch sensor pad (or simply “touchpad”) and image data (or simply “images”) from an imaging sensor. The present systems and methods utilize a single-touch sensor pad that can report the 2-D coordinates Pₐᵥ, where Pₐᵥ=(Xₐᵥ, Yₐᵥ), of an average touchpoint of multiple touchpoints when a user places two or more fingertips on the surface of the single-touch sensor pad. To compute correct 2-D coordinates of each fingertip, the present systems and methods use the 2-D coordinates, Pₐᵥ, of an average touchpoint in combination, or fused, with image data captured from an imaging sensor. Data fusion refers generally to the combined data from multiple sources in order to identify inferences. In the present systems and methods data fusion relates to the combination of data from the touchpad 20 and the imaging sensor 22 to more efficient and narrowly identify the location of fingers that if they were identified separately. Using data fusion, the present systems and methods can determine the 2-D location of each fingertip (or touchpoint) on the surface of touchpad.

### Hardware Structure and its Usage

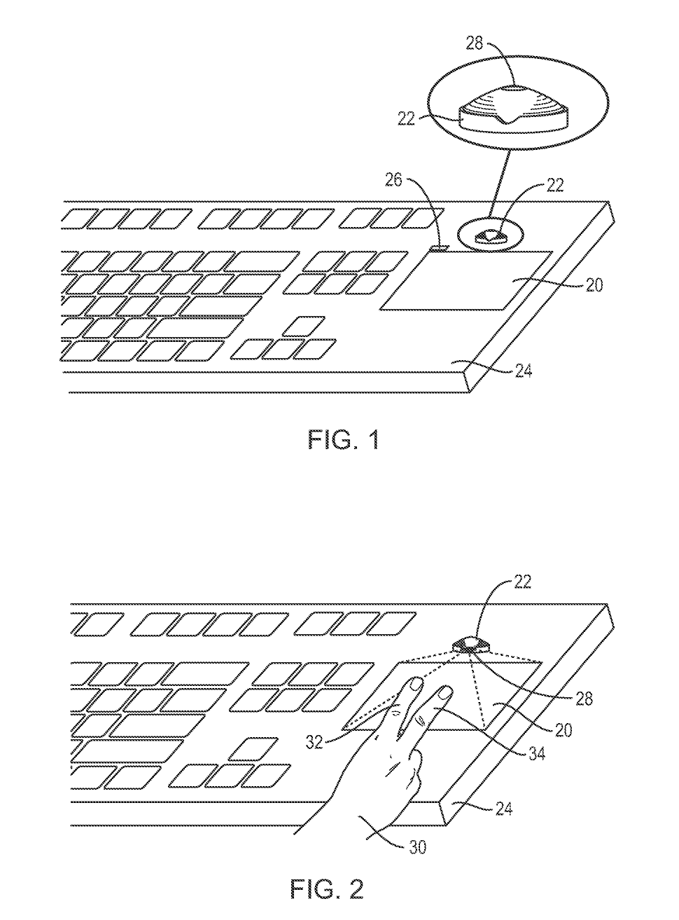

FIG. 1 depicts an embodiment of hardware that incorporates the present input system. As shown, in some instances, the input system includes a keyboard 24 having a touchpad 20 and an imaging sensor 22 on its body.

The imaging sensor 22 can be low-resolution, black-and-white imaging sensor 22 configured for data fusion purposes (e.g., a CMOS sensor with CGA resolution of 320×200 black and white pixel). The imaging sensor 22 is mounted on a keyboard 24 adjacent the touchpad in a manner that allows a sensor camera 28 of the imaging sensor 22 to capture images of user's finger on the surface of touchpad 20 or capture a user's finger in free space above the touchpad 20 and/or imaging sensor 22. In some embodiments, the angle of sensor camera 28 of the imaging sensor 22 can be movable in order to change a camera angle (including both the vertical and horizontal angle of orientation) of the sensor camera. The movement of the sensor camera 28 can be automatic or manual. For example, the sensor camera 28 can sense the location of a user's hand 30 and automatically adjust its orientation toward the user's hand 30. The movement of the sensor camera 28 is represented in FIGS. 1 and 2, wherein in FIG. 1 the sensor camera 28 is oriented upwardly, while in FIG. 2 the sensor camera 28 is oriented towards the touchpad 20.

As an optional design feature, a light 26, such as a small LED light, can be installed on the keyboard 24 adjacent to the touchpad 20 to provide light to the touchpad 20 area and the area above the touchpad 20 and/or above the imaging sensor 22. Thus, in some configurations, the light 26 is configured to illuminate at least the touchpad 20 and a portion of a user's fingers when the user's fingers are in contact with the touchpad 20. Some embodiments may benefit by providing a movable light that can move manually or automatically to change the angle of illumination along two or more planes.

FIG. 2 depicts a usage of the system for multi-touch input generation using the combination of the touchpad 20 and the imaging sensor 22. As shown, the angle of sensor camera 28 of the imaging sensor 22 is oriented towards the touchpad 20 so that the sensor camera 28 can capture the entire surface of the touchpad 20 and the fingers 32, 34 and/or hand 30 of the user. Thus oriented, the sensor camera 28 can capture the user's hand gestures (which refer herein to both hand and finger gestures) on the surface of touchpad 20. By fusing the data generated from the touchpad 20 and imaging sensor 22, a multi-finger input can be generated. This type of input can be a first type multi-finger input in a dual-input system. The process of data fusion will be described in greater detail below.

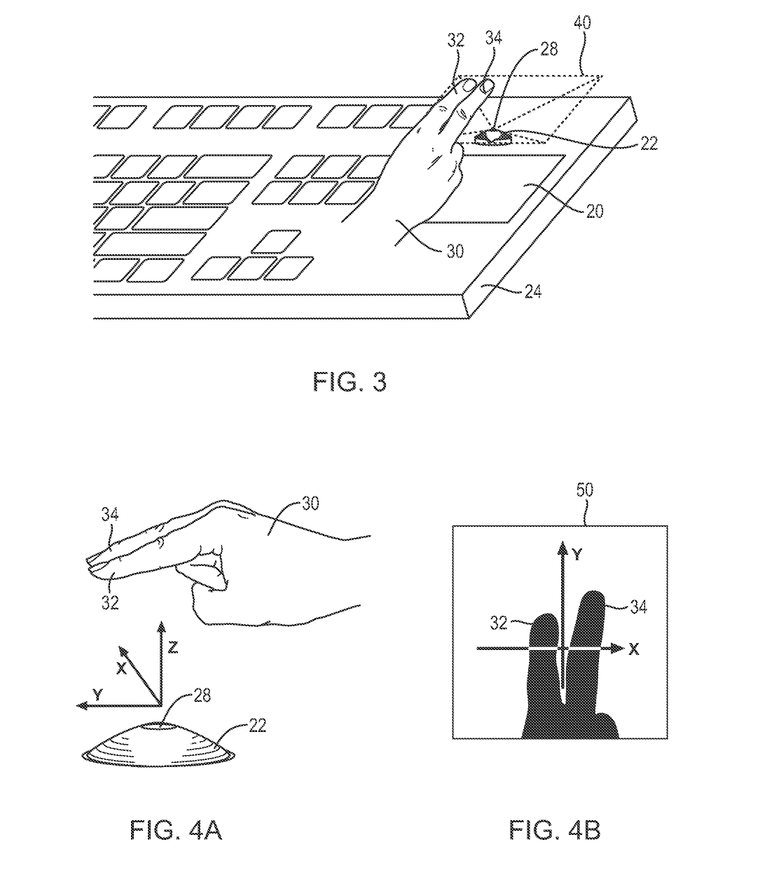

FIG. 3 depicts an imaging sensor 22 in use as an independent input device. As shown, the imaging sensor 22 can capture hand gestures of the user made in free space (e.g., within a virtual plane 40) above the surface of the touchpad 20 and/or above the imaging sensor 22. The captured images can be processed using a real-time template (object image) tracking algorithm of the firmware that translates user hand gestures into multi-touch input commands. In some instances, hand gestures made in free space can be a second type multi-finger input in a dual-input system. In other instances, the two types of inputs described can be used separately.

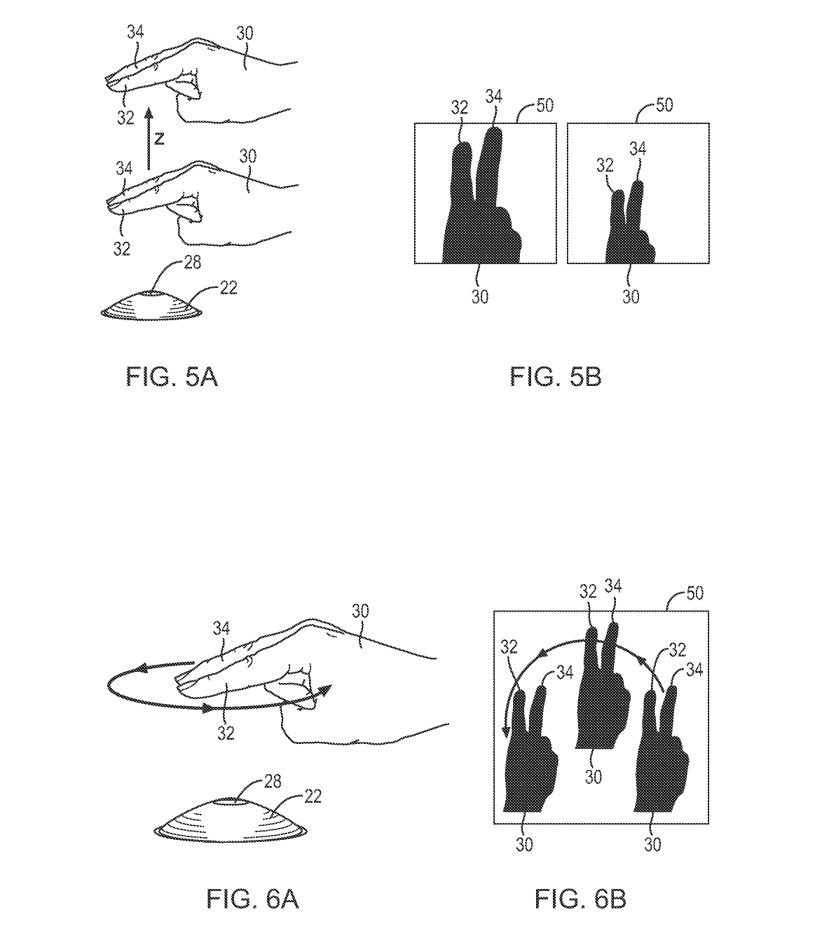

FIGS. 4A through 6B depict representative operations of the imaging sensor 22 to capture images of hand gestures. For instance, FIG. 4A depicts a hand configuration made in free space (in 3-D, within an X-Y-Z coordinate system) along the X-Y axes above the imaging sensor 22. FIG. 4B depicts the 2-D image (in an X-Y coordinate system) of the hand position captured by the imaging sensor 22. Similarly, FIG. 5A depicts a hand gesture made along the Z-axis above the imaging sensor 22, and FIG. 5B depicts the images of the hand gesture captured by the imaging sensor 22. Lastly, FIG. 6A depicts a rotating-hand gesture made above the imaging sensor 22, and FIG. 6B depicts the resulting series of images (superimposed on a single image).

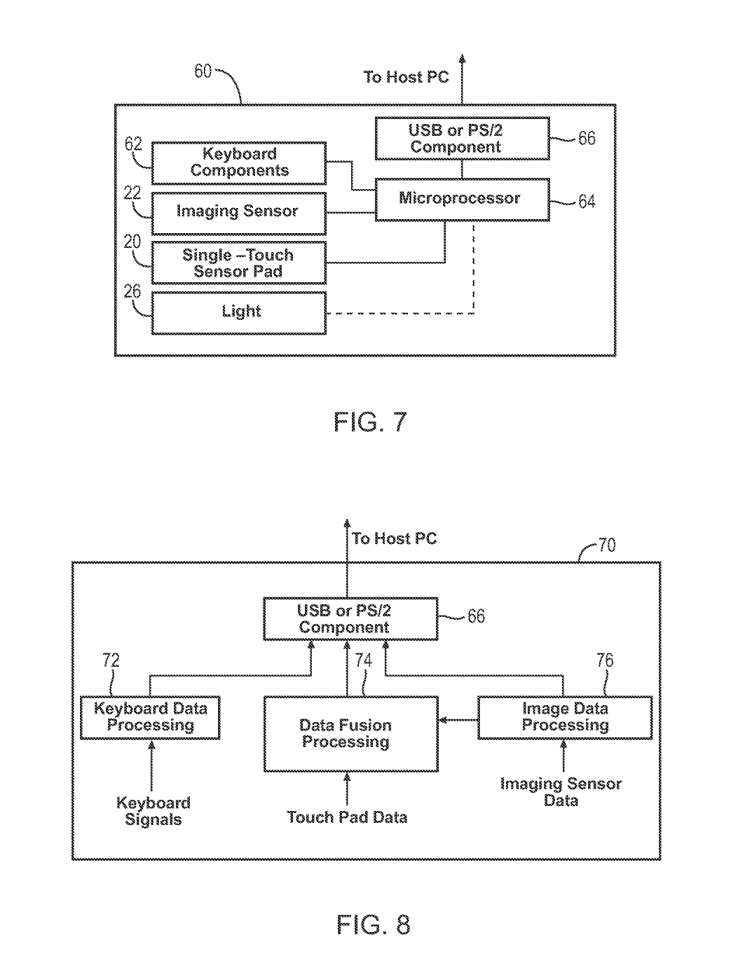

FIG. 7 depicts a block diagram of representative hardware components of the input system 60. As shown, a microprocessor 64 can be coupled to and receive data from the keyboard complements 62, the imaging sensor 22, the touchpad 20, and (optionally) the light 26. The microprocessor 64 can acquire data packets from each of these components. The microprocessor 64 can be connected to a host PC using a wired/wireless USB connection or PS/2 connection 66. The microprocessor 64 can thus communicate with the host PC the data packets acquired from these components.

### Firmware Structure and Functions

FIG. 8 depicts a function block diagram of firmware 70 used in some embodiments of the present systems and methods. As shown, the firmware 70 can define three logical devices (even if hardware is each of these logical devices is physically embodied in a single device). The first logical device 72 processes keyboard signals from a conventional keyboard. The second logical device 74 fuses data from the touchpad 20 and the third logical device 76. The third logical device processes image data from the imaging sensor 22.

In the data processing in the second logical device 74, the firmware 70 acquires a data from the touchpad 20 that identifies the presence or absence of a touchpoint on the touchpad 20 and the position or coordinates of the touchpoint if there is a touchpoint. The firmware 70 also acquires images from the imaging sensor 22. The acquired images can be acquired as data representing a pixilated image. Using this acquired data, the firmware 70 can identify a hand gesture made by the user's one or more fingers and generate a multi-touch command based on the identified hand gesture. The final, output from the second logical device 74 is in the same format as that of a multi-touch sensor pad. The third logical device 76 of the firmware 70 can perform real-time template tracking calculations to identify the 3-D location and orientation of an object corresponding to the user's finger-hand in a free space. This third logical device can operate independent of the second logical device when the user's hand is not touching the touchpad 20. Additional functions of the firmware 70 will be described below.

### Data Fusion Algorithm

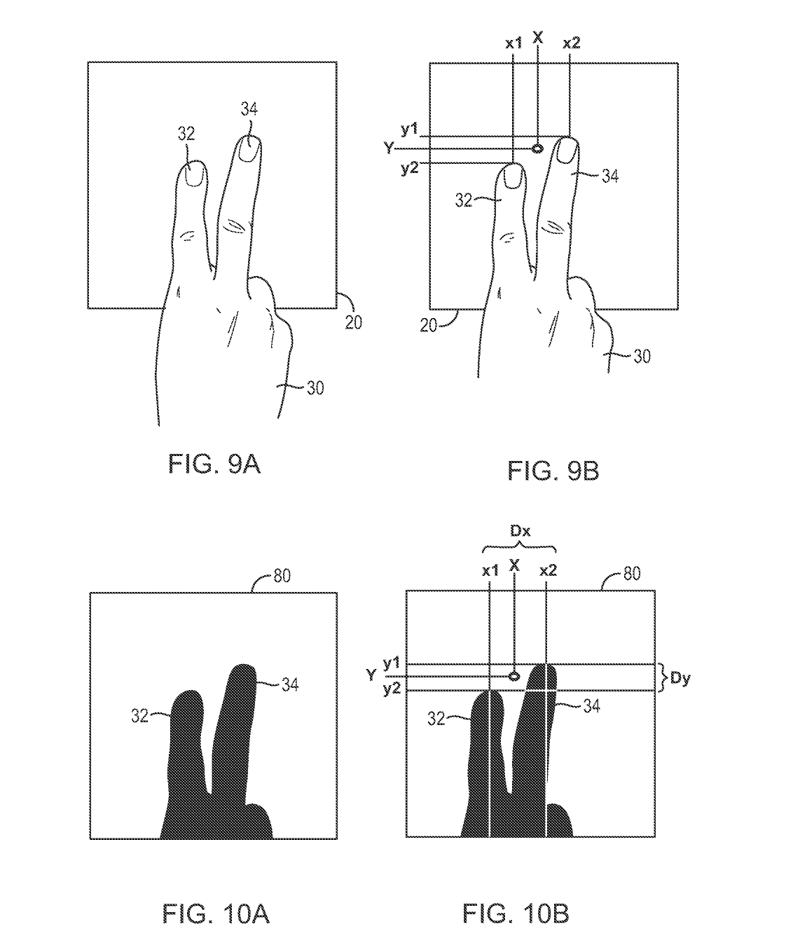

The following description explains the process of identifying a multi-touch location using a data fusion algorithm within the firmware 70. As background, FIGS. 9A through 9B illustrate the acquisition of a single, average touchpoint (X, Y) from the touchpad 20 when in fact there are two or more touchpoints on the touchpad 20. Specifically, FIGS. 9A and 9B depict two fingers 32, 34 touching the touchpad 20 and an average touchpoint (X, Y) of the two actual two touchpoints, (X₁, Y₁) and (X₂, Y₂), on the touchpad 20. Since the touchpad 20 is a single-touch sensor pad, it may only be capable of sensing and outputting a single, average touchpoint (X, Y).

An explanation of a data fusion algorithm used to compute the actual location of each touchpoint on the touch pad 20 will now be provided. Initially, the firmware 70 acquires an average touchpoint (X, Y), as illustrated in FIGS. 9A and 9B, from the one or more touchpoints on the touchpad 20. The firmware 70 can also acquire an image from imaging sensor 22 at this time. The firmware 70 can converts and/or processes this image to a binary image having only black or white pixels to facilitate finger recognition. At this point, the individual locations of separate touchpoints are unknown.

The firmware 70 can then iterate through the following steps. After the average touchpoint (X, Y) is acquired, it is mapped onto a pixel coordinate system, as shown in FIG. 10B. The firmware 70 can then fuse this data with the image acquired by the imaging sensor 22 by also mapping all or just a portion of the image on the same coordinates, as also shown in FIG. 10B. It will be understood, that the firmware 70 can map the relative coordinates of the image onto the coordinates of the touchpad 20 to accommodate for the camera angle and placement of the imaging sensor 22 relative to surface of the touchpad 20. Next, the firmware can identify the location of the edges of the fingers depicted in the image or portion of the image. This may be done by scanning some pixel lines along the X-axis and the Y-axis around the location of the average touchpoint to recognize the edges of the fingers. In some instance, the firmware 70 can identify specific scan line row index data (X-axis line) and column index data (Y-axis line) corresponding to identify the object edges.

Next, once the edges of the fingers are identified, the firmware 70 can detect the number of fingers in the image and thus the number of touchpoints on the touchpad 20. The firmware can also use the coordinate system to measure the distance between the finger tips depicted in the image, which can be used to detect the distance between the touchpoints. In case of two touchpoints, the detected distance between the coordinates of the two touchpoints can be given values, Dₓ and D_{y}, as shown in FIG. 10B.

Next, the firmware 70 can identify the coordinates of the two or more actual touchpoints. For example, when two touchpoints are detected, the firmware 70 can compute the coordinates of the first touchpoint (X₁, Y₁) and the second touchpoint (X₂, Y₂) using the known values of (X, Y), D_{x,} and D_{y}, and the following equations:

X₁=X−Dₓ/2; Y₁=Y−D_{y}/2;

X₂=X+Dₓ/2; Y₂=Y+D_{y}/2;

Lastly, if the data sequence of a set of subsequent touchpoint coordinates results in one or more jerky movements, then this set of touchpoint coordinates can be smoothed out by filtering them with a filter, such as a digital low pass filter or other suitable filter.

As noted, the image processing for the second logical device 74 of the firmware 70 does not adopt a typical image processing method for tracking touchpoints, such as a real-time template (object shape) tracking algorithm. These typical methods require heavy computational power on microprocessor 64. The present methods can reduce the computational load on the microprocessor 64 by scanning a one dimensional pixel line adjacent to the averaged touchpoint mapped onto the imaging sensor's pixel coordinates to estimate the distance between fingertips. Accordingly, the method of data fusion using the averaged touchpoint from touchpad 20 and partial pixel data from imaging sensor 22 can provide a significantly reduced computational burden on the microprocessor 64 compared with traditional real-time image processing methods.

### Multi-Dimensional Input Commands

As mentioned, the fusion of data from the touchpad 20 and the imaging sensor 22 can be used to generate multi-touch commands. When using data fusion to generate multi-touch commands, both the touchpad 20 and the imaging sensor 22 are used as primary inputs and independently utilized for input command generation. A real-time, template-tracking algorithm can also be used by the firmware 70.

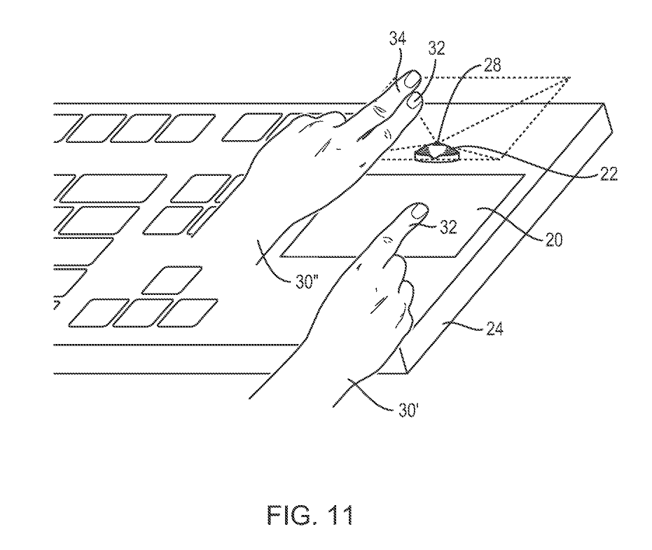

FIG. 11 depicts multi-touch command generation using data from both the touchpad 20 and the imaging sensor 22, which can be done separately or simultaneously using one or two hands. In these instances, images from imaging sensor 22 are not used for detection of multiple fingertip location on the touchpad 20, but for identifying a finger and/or hand location in free space and for recognizing hand gestures. FIG. 11 shows a user using a finger 32 of right hand 30′ on the touchpad 20 to generate a single-touch input command. The user is also using his/her left hand 30″ to generate a separated input command, a multi-touch command.

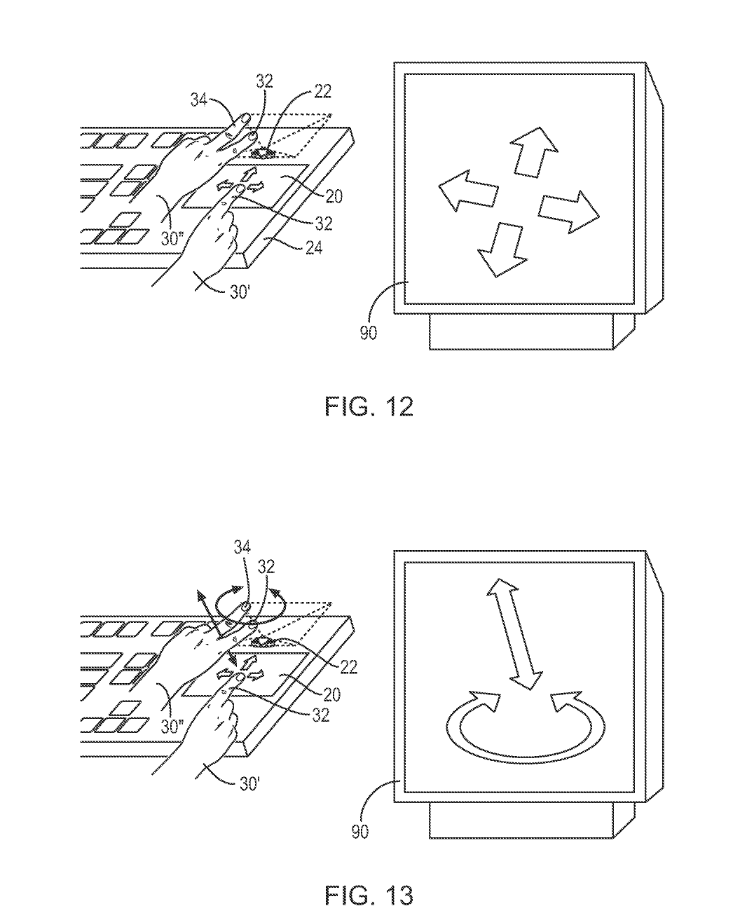

For example, FIG. 12 depicts the 2-D translation command generation by moving a first hand 30′ on the touchpad 20. In this figure, a user is depicted as dragging a single finger 32 on the surface of touchpad 20 to generate 2-D camera view commands for a 3-D software application, such as Google Earth. Such right-left directional movements of the finger on the touchpad 20 can be used for horizontal translation command of camera view. The forward-backward directional movement of finger is used for forward-backward translation command of camera view. These movements can control a software program displayed on a display device 90.

Continuing the example, FIG. 13 depicts yaw and zoom command generation produced by moving the second hand 30″ in free space above the imaging sensor 22. In this figure, the user is rotating his/her hand 30″ around the axis perpendicular to the camera of imaging sensor 22. The image-processing algorithm, such as a real-time template tracking algorithm, can recognize the angle of template rotation and generate, for example, yaw command for camera view (rotation about Z-axis). The hand translation gesture along the axis toward the camera of imaging sensor could be identified by the image-processing algorithm to generate, for example, a zoom in or zoom out command in the software application. These movements can control a software program displayed on a display device 90.

### Command Generation by a Finger Hovering Gesture in the Proximity of Touchpad

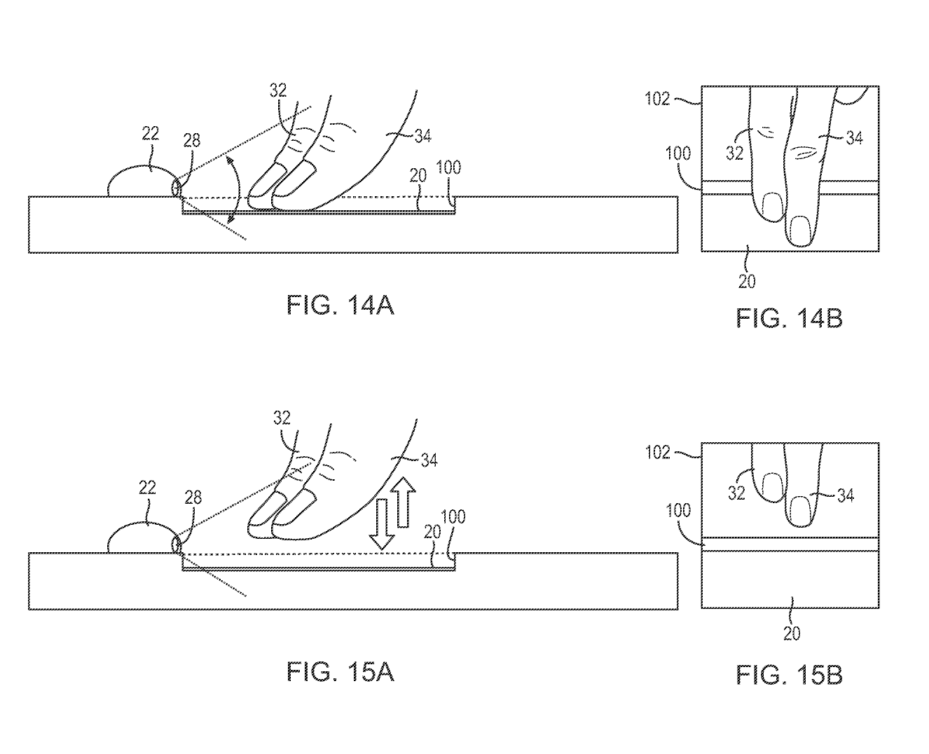

In some embodiments, the present systems and methods provide a multi-touch input gesture that is generated by a finger hovering gesture in the proximity of the surface of the touchpad 20. As shown in FIGS. 14A and 15A, by carefully adjusting the view angle of imaging sensor 22, the imaging sensor 22 can capture the surface of the touchpad 20, a user's finger(s), and a bezel area 100 of touchpad 20. The bezel area 100 can be a sidewall surrounding a touchpad 20 that is recessed or lowered within a surface of the keyboard 24 or other body. The bezel area 100 can thus comprise the wall extending from the surface of the keyboard down to the surface of the touchpad 20.

Thus configured, the imaging sensor 22 can detect not only the 2-D finger positions of the fingers 32, 34 on the local X-Y coordinates on the touchpad 20, but also the vertical distance (along the Z-axis) between user's fingertips and the surface of touchpad 20. The data relating to the fingertip positions in proximity to the touchpad 20 can be used for Z-axis related commands such as Z-axis translation or creation of multiple modal controls for multi-finger, gesture-based input commands.

FIG. 14A depicts a user's fingers 32, 34 in contact with the surface of touchpad 20. FIG. 14B depicts the image 102 by captured the imaging sensor 22 corresponding to the user's fingers 32, 34 in FIG. 14A. FIG. 15A depicts user's finger location after it is moved from the contact position, show in FIG. 14A to a hovering position above the surface of touchpad 20. FIG. 15B depicts the image captured by the imaging sensor 22 corresponding to the user's fingers 32, 34 in FIG. 15A.

In some configurations, the imaging sensor 22 is tuned to identify both the local X-Y position of fingers 32, 34 on and above the touchpad 20 and a hovering distance of the fingers 32, 34 above the touchpad 20. This identification can be made by comparing sequential image frames (e.g., the current and previous image frames), such as the image frames of FIGS. 14B and 15B. The imaging sensor 22 can then be tuned to identify the approximated X, Y, and Z position changes of the fingers 32, 34.

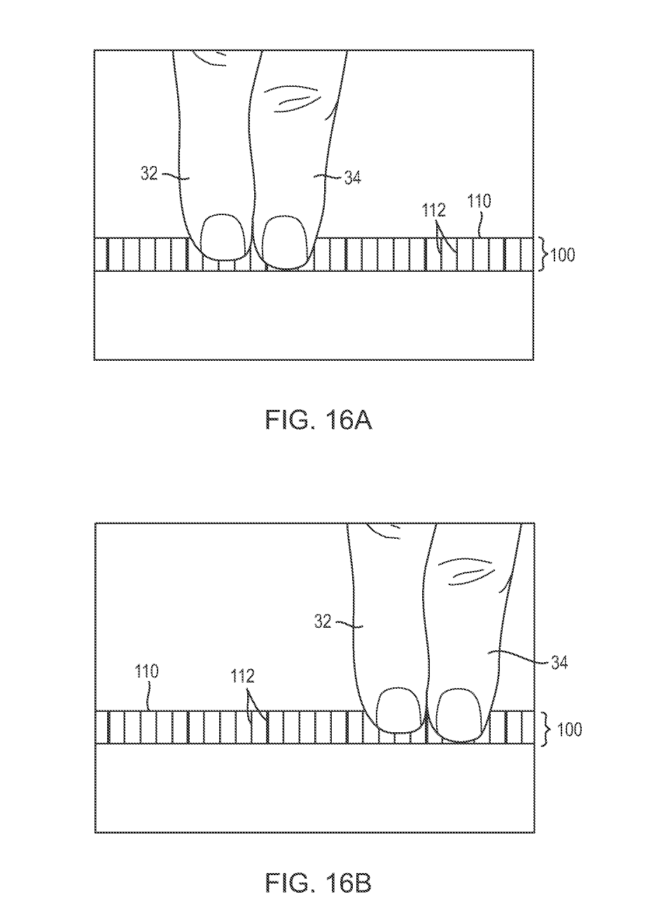

When a user's finger contacts the surface of touchpad 20, the absolute location of the touchpoint is identified by data fusion, as previously described. However, after the user's fingers 32, 34 are lifted to hover over the touchpad 20 surface, data fusion may not be able to identify the exact 2-D location of fingers 32, 34. In these instances, the imaging sensor 22 can estimate the position change on X-axis using the comparison of captured frame image between previous frame and current frame. For example, FIG. 16A and FIG. 16B depict two such sequential image frames that can be compared to detect an X-axis position change by identifying the differences between these sequential image frames.

In the example depicted in FIG. 16A and FIG. 16B, the firmware 70 can identify and compare the images using one or more visual features of the retroreflector 110 to estimate the position change of the fingers 32, 34 along X-axis. FIG. 16A and FIG. 16B show a representative retroreflector 110 disposed on the outer boundary region (the bezel 100) of touchpad 20 for assisting in image recognition. As shown, the retroreflector 110 can include one or more visual features, such as lines 112, grids, or another pattern that provide an optical background image used to measure and/or estimate the relative movement and change of position of fingers 32, 34 along the X-axis. In some instances, the retroreflector 110 includes a thin film material with a surface that reflects light back to its source with a minimum scattering of light. The firmware 70 can be configured to detect the change in position of the fingers 32, 34 along the lines 112 of the retroreflector 110 since the fingers 32, 34 block the reflection light from the retroreflector 110. This detected movement of the fingers 32, 34 can be converted into the pre-defined position change value of fingers 32, 34 on the X-axis translation.

In some embodiments, the firmware 70 can also detect the Y-axis (forward/backward movement) of a finger that is hovering over the touchpad 20. In these embodiments, the firmware 70 and/or imaging sensor 22 can utilize the same method depicted in FIG. 4 and described above. This method includes comparing the finger image size (change of scaling) between subsequent image frames to estimate the Y-axis position change of fingers 32, 34.

As will be understood from the foregoing, the present systems and methods can be used to generate multi-touch commands from hand gestures made both on the surface of the touchpad 20 and made while hovering the fingers over the surface of the touchpad 20. Examples of multi-touch commands made while contacting the touchpad 20 can include scrolling, swiping of web pages, zooming of text image, rotating pictures, and the like. Similarly, multi-touch commands can be made by hovering the fingers over the touchpad 20. For example, moving a hovered finger in a right/left direction can signal an X-axis translation. In another example, moving a hovered finger forward/backward direction can signal a Y-axis translation. In other examples, moving two hovered fingers in the right/left direction can signal a yaw command (rotation about Y-axis), while moving two hovered fingers forward/backward can signal a pitch command (rotation about X-axis). In a specific instance, commands made by hovering a finger can provide the commands for camera view change of 3-D map, such as Google Earth.

In some configurations, hand gestures made on the surface of the touchpad 20 trigger a first command mode, while hand gestures made while hovering one or more fingers over the touchpad 20 trigger a second command mode. In some instances, these two modes enable a dual-mode system that can receive inputs while a user makes hand gestures on and above a touchpad 20. Thus, the user can touch the touchpad 20 and hover fingers over the touchpad 20 and/or the imaging sensor 22 to provide inputs to a software program.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A system for generating a multi-touch command, comprising:
a single-touch sensor pad;
an imaging sensor disposed adjacent to the single-touch sensor pad, the imaging sensor being configured to capture one or more images of a user's fingers on or above the single-touch sensor pad; and
firmware configured to acquire data from the single-touch sensor pad and use it with the one or more images from the imaging sensor to generate a multi-touch command.

2. The system of claim 1, wherein the firmware is further configured to recognize a position and movement of the user's fingers by comparing sequential images of the one or more images captured by the imaging sensor.

3. The system of claim 1, wherein the imaging sensor comprises a sensor camera.

4. The system of claim 3, wherein the sensor camera is movable to change a camera angle of the sensor camera.

5. The system of claim 1, further comprising a bezeled area disposed on the outer boundary of the single-touch sensor pad.

6. The system of claim 5, further comprising a retroreflector disposed on at least a portion of the bezeled area, the retroreflector having lines or a grid included thereon.

7. The system of claim 6, wherein the firmware is further configured to recognize the position and movement of the user's fingers by comparing sequential images of the one or more images captured by the imaging sensor and by recognizing the position of the lines or grid of the retroreflector in relation to the position of the user's fingers in the sequential images.

8. The system of claim 1, further comprising a light disposed adjacent to the single-touch sensor pad and configured to illuminate at least the single-touch sensor pad and a portion of a user's fingers when the user's fingers are in contact with the single-touch sensor pad.

9. A method for generating a multi-touch command with a single-touch sensor pad, the method comprising:
acquiring data from a single-touch sensor pad, the data identifying the presence or absence of a touchpoint on the single-touch sensor pad, the data further identifying the position of the touchpoint when the data identifies the presence of a touchpoint, the touchpoint resulting from one or more fingers of a user contacting the single-touch sensor pad;
acquiring one or more images of the user's one or more fingers from an imaging sensor;
identifying, using firmware, a hand gesture made by the user's one or more fingers using the data from the single-touch sensor pad and the one or more images; and
generating, using the firmware, a multi-touch command based on the identified hand gesture.

10. The method of claim 9, wherein the position of the touchpoint is the position of an average touchpoint; and the method further comprising identifying two or more actual touchpoints on the single-touch sensor pad using the firmware, the position of the average touchpoint, and the one or more images.

11. The method of claim 10, further comprising:
mapping the position of the average touchpoint onto a coordinate system;
mapping at least a portion of the one or more images on the coordinate system;
identifying the location of the edges of the fingers in the at least a portion of one or more images on the coordinate system;
determining the number of the two or more actual touchpoints and the distance between the two or more actual touchpoints; and
identifying the coordinates of the two or more actual touchpoints.

12. The method of claim 11, wherein the at least a portion of the one or more images is a portion of the one or more images in proximity to the position of the average touchpoint.

13. The method of claim 11, further comprising filtering a set of identified coordinates of the two or more actual touchpoints to filter out jerky movements.

14. The method of claim 9, wherein identifying a hand gesture comprises identifying a hand gesture made by the user's one or more fingers using only the one or more images when the data identifies the absence of a touchpoint on the single-touch sensor pad.

15. The method of claim 14, further comprising comparing two or more sequential images of the one or more images to detect a user hand gesture.

16. The method of claim 15, further comprising:
identifying one or more visual features of a retroreflector in the two or more sequential images; and
identifying a movement of the user's one or more fingers in the two or more sequential images based on the location of a user's one or more fingers in relation to the one or more features of the retroreflector in the two or more sequential images.

17. The method of claim 15, wherein identifying a hand gesture comprises using a real-time template-tracking algorithm.

18. The method of claim 9, wherein when the data identifies the absence of a touchpoint on the single-touch sensor pad, identifying a hand gesture comprises identifying a hand gesture made in free space.

19. The method of claim 9, wherein when the data identifies the presence of a touchpoint on the single-touch sensor pad, identifying a hand gesture comprises identifying a hand gesture made at least partially on the touchpad.

20. A method for generating a multi-touch command with a single-touch sensor pad, the method comprising:
acquiring data from a single-touch sensor pad, the data identifying the presence or absence of a touchpoint on the single-touch sensor pad, the data further identifying the position of the touchpoint when the data identifies the presence of a touchpoint, the touchpoint resulting from one or more fingers of a user contacting the single-touch sensor pad;
acquiring one or more images of the user's one or more fingers from an imaging sensor;
identifying, using firmware, a hand gesture made by the user's one or more fingers using the data from the single-touch sensor pad and the one or more images when the data identifies the presence of a touchpoint on the single-touch sensor pad, and identifying a hand gesture using only the one or more images when the data identifies the absence of a touchpoint on the single-touch sensor pad; and
generating, using the firmware, a multi-touch command based on the identified hand gesture.
